(19) United States
(12) Patent Application Publication
(10) Pub. No.: US 2013/0221285 A1
(43) Pub. Date: Aug. 29, 2013

(54) HYBRID POLYMER COMPOSITES FOR ELECTROMAGNETIC WAVE SHIELDING, AND A METHOD FOR FABRICATING THE SAME

(71) Applicants: Kyong Hwa SONG, Seoul (KR); Han Saem LEE, Ansan (KR); Jin Woo KWAK, Suwon (KR); Byung Sam CHOI, Gunpo (KR)

(72) Inventors: Kyong Hwa SONG, Seoul (KR); Han Saem LEE, Ansan (KR); Jin Woo KWAK, Suwon (KR); Byung Sam CHOI, Gunpo (KR)

(73) Assignee: HYUNDAI MOTOR COMPANY, Seoul (KR)

(21) Appl. No.: 13/461,245

(22) Filed: May 1, 2012

(30) Foreign Application Priority Data
Feb. 23, 2012 (KR) 10-2012-0018464

(51) Int. Cl. H01B 1/04; B29C 43/18; B82Y 30/00; B82Y 40/00

(52) U.S. Cl. 252/511; 427/331; 977/742; 977/750; 977/752; 977/900

(57) ABSTRACT

Disclosed is a hybrid polymer composite for electromagnetic wave shielding, and a method for fabricating the same. Specifically, the hybrid polymer composite may be fabricated by combining a microcapsule that is surface coated with at least one carbon nanotube and includes a phase change material (PCM), whose phase easily transitions from solid to liquid upon exposure to heat, with at least one carbon fiber and a matrix polymer. The disclosed hybrid polymer composite has enhanced electromagnetic wave shielding properties that result, in part, from the ability of the PCM to dissipate and remove heat generated by electromagnetic absorption. Additionally, the disclosed composite has excellent conductivity due to its polymer properties and the formation of a network between fillers and the polymer.

### CROSS-REFERENCE TO RELATED APPLICATION

This application claims under 35 U.S.C. §119(a) the benefit of Korean Patent Application No. 10-2012-0018464 filed on Feb. 23, 2012, the entire contents of which are incorporated herein by reference.

### BACKGROUND

(a) Technical Field

The present invention relates to a polymer composite for electromagnetic wave shielding in a variety of electronics applications. More particularly, the present invention relates to a hybrid polymer composite including a microcapsule containing a phase change material (PCM) and surface coated with a carbon nanotube, and a carbon fiber and a matrix polymer, and a method for fabricating the same. The hybrid polymer composite has enhanced electromagnetic wave shielding and conductivity properties;

(b) Background Art

It is known that electromagnetic waves represent a serious threat to the development of a variety of technologies such as, for example, information and communication technologies, computer technologies, automotive technologies, and the like. For example, the malfunction of a radio-communication device by the generation of electromagnetic wave may cause serious danger to both the safety of the electronic equipment itself, and the safety of the people who depend on the communication device. As another example, electromagnetic waves have become an increasing problem in automotive applications as a result of interference between parts and components caused by the rapid increase in the use of electronic devices, and noise created by the use of high frequencies, which may affect the function of a variety of other components in the vehicle, thereby causing a vehicle accident.

Many electronic parts are increasingly required to be lightweight and have various shapes and designs because of the expansion of the use of electronic equipments in vehicles, as well as the rapid increase in the use of mobile displays. In order to meet these demands, there is a continuous desire to use plastic as the material for these types of parts. Plastic is lightweight and, through molding, its design can be easily changed to various shapes; therefore, its use in electronics applications will likely continue to increase. Disadvantageously, plastic cannot be used as a housing material for electronic parts that require electromagnetic wave shielding because it does not have the conductivity of metal. Further, because most plastics are intrinsically electric insulators, electromagnetic waves can easily pass through a plastic polymer without any loss, or dissipation, thereto. This characteristic may cause a big problem when the polymer is used for the case of electronic equipment such as computers, mobile phones, and the like.

In order to solve the drawbacks of plastic, research has focused on preparing a composite by adding a filler having excellent conductivity. For example, the electromagnetic wave shielding of a plastic composite may be produced by dispersing at least 30 vol % of a metal powder having excellent electrical conductivity throughout the plastic, or by using carbon fiber to an amount of 30 volume % or more in a polymer, such as silicone rubber, polyurethane, polycarbonate, epoxy resin, and the like. It is known that the use of a metal powder, such as, e.g., silver (Ag) powder or silver coated copper (Ag-coated Cu), has excellent electrical conductivity when dispersed in the polymer to the amount of 30 volume %, and it is possible to obtain a volume resistance of 0.01 Ω-cm or less and achieve a shielding efficiency of about 50 dB.

In order to comply with the electromagnetic wave shielding standards, which have recently become quite strict, it is now necessary to achieve a lower volume resistivity and a higher shielding effect. To this end, it is necessary to disperse a larger quantity of metal powder, such as silver powder, in the polymer. However, when such a large quantity of silver powder is dispersed in the polymer, the electromagnetic wave shielding effect may be improved by the improvement of the electrical conductivity, however, the mechanical properties of the material, such as impact strength, are degraded. Consequently, there are many significant limitations in the application of a metal powder as an electromagnetic wave shielding material. Therefore, there is an urgent need for the development of an electromagnetic wave shielding material that is inexpensive, light-weighted, strong, easy to prepare and process, and durable under various environmental conditions as well as to develop a novel electronic equipment.

As an alternative, it has been suggested that carbon nanotube may be used as a filler for electromagnetic wave shielding. Carbon nanotube is a material having a shape of an elongated tube made of carbon molecules and having a nano-sized diameter, an electrical conductivity 1000 times higher than that of Cu, a high strength and modulus of elasticity corresponding to 100 times that of steel, and high aspect ratio of a length to a diameter. Accordingly, the polymer composite, in which the carbon nanotube is dispersed in a polymer matrix, has been noted in one aspect as being capable of being used as a functional material, such as a material having a high strength relative to its weight, a conductive material, and an electromagnetic wave shielding material. In a case of using the aforementioned carbon nanotube, although there is a slight difference of the volume ratio depending on the type of polymer matrix, even if at least 0.04 vol % of the carbon nanotube is dispersed, a conductive network may be formed to achieve a low volume resistivity. However, when the carbon nanotube is used alone, no matter how many carbon nanotubes are used, the volume resistance becomes high—being at least 10 Ω-cm—when it is mixed with the polymer; therefore, it fails to achieve an electromagnetic wave shielding effect. Further, the carbon nanotube is poorly dispersed, even when present in a very small amount; consequently, there is a limitation in the ability to apply it to a composite for use as an electromagnetic wave shielding material.

For this reason, attempts have been made in the conventional art to use various mixed fillers for adding metal powder in order to increase conductivity. For example, one such attempt has been made using a biodegradable synthetic resin composition prepared by mixing a biodegradable resin and a latent heat powder with mixing, followed by pelleting and crystallizing thereof. Unfortunately, this synthetic resin composition fails to provide a sufficiently high level of electromagnetic wave shielding.

Furthermore, other attempts to produce an electromagnetic wave shielding material have been made by mixing a carbon nanotube such as a single walled nanotube (SWNT), a multi-walled nanotube (MWNT), and the like, with a metal powder as a conductive filler, and using a polymer resin as a matrix; however, these materials also fail to adequately address the electromagnetic shielding problem. Additionally, most of the other conventional art patent applications have only focused on increasing conductivity to enhance the electromagnetic wave shielding characteristic, and have failed to consider other important characteristics of the material required for electronics applications, such as, for example, heat shielding, strength, moldability, and the like.

The principle addressing the ability to shield an electromagnetic wave in a polymer containing a conductive filler may be described by the following mechanism. Electromagnetic waves pass through air; and when the wave meets a polymer medium surface, some are reflected and others are bent and transmitted into the polymer medium. Once transmitted into the medium, the waves will become weak and dissipate due to multi-reflection or absorption when the waves meet a conductive nano-material inside of the polymer medium, or the electromagnetic waves may be extinguished, and only parts of the waves are transmitted. In other words, many of the electromagnetic waves are extinguished by being reflected or absorbed by fillers in the polymer composite. These absorbed electromagnetic waves create electron flow by vibrating electrons, and at this time, current is generated. Commonly, electron movement is emitted as heat energy, which makes continuous absorption of the electromagnetic field possible. However, if it is not emitted through heat energy or removed otherwise removed, the shielding effect may decrease over time. Therefore, heat energy removal may be correlated to increasing shielding efficiency. Accordingly, in order to shield the electromagnetic waves, the composite should ultimately contain both a material with a good electrical conductivity and a material with a good heat transfer. However, the solutions proposed above fail to provide such materials. Accordingly, there is a need in the art to develop composite materials that have excellent electrical conductivity and heat transfer/dissipation properties

### SUMMARY OF THE DISCLOSURE

Accordingly, it is an object of the present invention to provide a hybrid polymer composite for electromagnetic wave shielding. In an exemplary embodiment, the hybrid polymer composite is fabricated by compounding a microcapsule, which contains a phase change material (PCM) in a surfactant, and is surface coated with a carbon nanotube, with a carbon fiber and a matrix polymer. An exemplary hybrid polymer composite of the invention has both electromagnetic wave shielding characteristics and beneficial physical properties at the same time.

In another exemplary embodiment of the present invention, a hybridized polymer composite for electromagnetic wave shielding is fabricated by compounding a microcapsule, which contains a phase change material and is coated with a carbon nanotube on the surface thereof, a carbon fiber, and a matrix polymer.

In another aspect of the present invention, a method is provided for fabricating a hybrid polymer composite for electromagnetic wave shielding, which includes the following steps of: preparing an emulsion by adding a phase change material to a surfactant; preparing a carbon nanotube coating solution by dispersing a carbon nanotube in a melamine polymer; preparing a microcapsule by coating the emulsion with the carbon nanotube coating solution; preparing a mixture by compounding a carbon fiber and a matrix polymer to the microcapsule coated with the carbon nanotube; and compressing the compounded mixture using a compression mold to obtain the hybridized polymer composite.

### BRIEF DESCRIPTION OF THE DRAWINGS

The above and other features of the present invention will now be described in detail with reference to certain exemplary embodiments thereof, illustrated by the accompanying drawings, which are given hereinbelow by way of illustration only, and thus are not limitative of the present invention, and wherein:

FIG. 1 is a graph showing results of measuring the degree of electromagnetic wave shielding of the composites prepared in Example and Comparative Example; and

FIG. 2 is the microcapsule prepared in Example, which includes a phase change material.

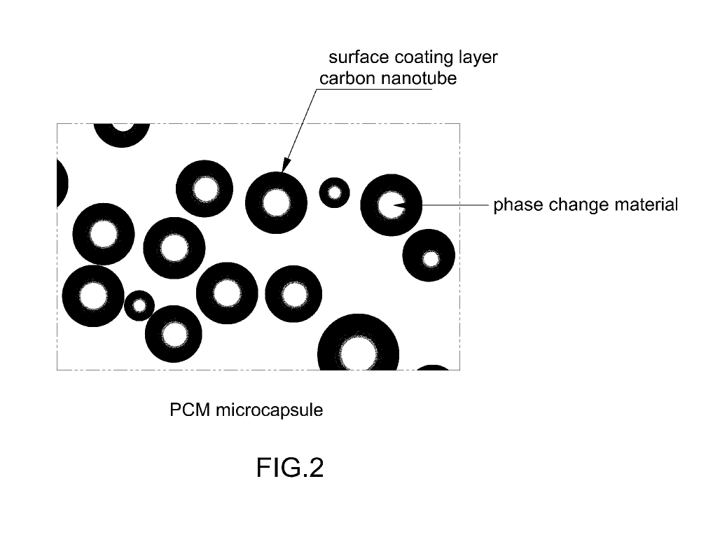

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Ranges provided herein are understood to be shorthand for all of the values within the range. For example, a range of 1 to 50 is understood to include any number, combination of numbers, or sub-range from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

The present invention is characterized by a hybrid polymer composite for electromagnetic wave shielding that is fabricated by compounding a microcapsule, which contains a phase change material and is surface coated with a carbon nanotube, with a carbon fiber and a matrix polymer.

The phase change material (PCM) may be at least one PCM selected from the group consisting of C₁₃₋₂₈ paraffin (CₙH₂ₙ₊₂) and fatty acid (CH₃(CH₂)₂ₙCOOH), and any mixture thereof, and the choice of PCM may vary according to the desired use of the composite. For example, octadecane may be selected as the phase change material in applications where a room temperate phase change is desired because its melting point is 28° C. In addition, because the melting points of tetradecane, pentadecane and octacosane are 5.5° C., 10° C., and 61° C., respectively, it is possible to select a phase change material that can be applied at various temperature ranges. Moreover, a mixture of two or more phase change materials may also be used. In a preferred embodiment of the invention, octadecane that undergoes a phase change around room temperature can be used.

Advantageously, the phase change material can control heat by absorbing or releasing heat while changing phase from a solid to a liquid, or vice versa, at a certain temperature. This phase change material is added to the polymerization process. The PCM is used in an encapsulated form in the capsule to maintain shape during the phase change, which allows the advantages of the two materials to be expressed simultaneously by coating the carbon nanotube, a conductive material having good shielding efficiency, on the microcapsule particle containing the phase change material, so as to create an exemplary hybrid polymer composite.

In an exemplary embodiment, the carbon nanotube may be at least one selected from the group consisting of single-walled carbon nanotube (SWNT), double-walled carbon nanotube (DWNT), and multi-walled carbon nanotube (MWNT). Most preferably, multi-walled carbon nanotube (MWNT) may be used. The thickness of the carbon nanotube coating layer may range from 50 nm to 500 nm. If the thickness of the coating layer is less than 50 nm, the layer may not sufficiently stabilize the capsule, and if the thickness of the coating layer is over 500 nm, it takes longer to deliver the heat absorbed in the carbon nanotube to the phase change material in the capsule.

In one illustrative embodiment, the size of the microcapsule may range from 1 μm to 100 μm. If the size of the microcapsule is less than 1 μm, it is difficult to maximize the dispersion effect when coating the carbon nanotube due to small size of the microcapsule, and if the size of the microcapsule is over 100 μm, it may affect the capsule stability and polymer properties. It is further contemplated that the amount of the carbon nanotube coated to the microcapsule may range from 0.1 to 10 wt %, preferably. The microcapsule may contain the PCM whose phase is changed by heat, and the PCM can absorb the heat generated when the electromagnetic wave is absorbed by the carbon nanotube layer having high conductivity. Therefore, shielding efficiency becomes higher than when the existing carbon nanotube was present alone because the heat energy caused by the electromagnetic wave can be removed more rapidly as a result of the PCM.

Furthermore, the reduction of the polymer properties that result from using the microcapsule can be offset with the carbon fiber because the carbon nanotube and the carbon fiber can naturally release the heat in the capsule to the outside through a network between the fillers because they possess excellent properties in terms of both thermal and electrical conductivity. The carbon fiber with good conductivity can maintain the polymer properties as being distributed between the microcapsules in the polymer matrix, and can naturally form a conductive network by being overlapped with the carbon nanotube coated on the capsule.

A thermoplastic resin may be used as the matrix polymer to fabricate the polymer composite. For example, the thermoplastic resin may be at least one selected from the group consisting of polyethylene, polypropylene, polystyrene, polyalkylene terephthalate, polyamide resin, polyacetal resin, polycarbonate, polysulfone, polyimide, and a mixture thereof. The thermoplastic resin has an advantage in that it can form a conductive pass better than a non-crystalline resin due to the characteristics of a crystalline resin, which occupies the crystalline region of the polymer during crystallization to push the filler outward.

In another aspect of the present invention, the polymer composite for electromagnetic wave shielding may be fabricated by a method comprising the steps of: preparing an emulsion by adding a phase change material to a surfactant; preparing a carbon nanotube coating solution by dispersing a carbon nanotube in a melamine polymer; preparing a microcapsule by coating the emulsion with the carbon nanotube coating solution; preparing a mixture by compounding a carbon fiber and a matrix polymer to the microcapsule coated with the carbon nanotube; and compressing the compounded mixture using a compression mold to obtain the hybridized polymer composite.

As an example, the surfactant may be at least one selected from the group consisting of carboxylate, sulfonate and sulfuric acid ester salt. The surfactant can emulsify the phase change material, and be selected according to a reaction solvent and characteristics of the phase change material.

Further, the mixing ratio of the surfactant and the phase change material may be 2:1, preferably. If the amount of the phase change material is more than that of the surfactant, the phase change material may not be completely emulsified, and if the amount of the phase change material is less than that of the surfactant, the surfactant may act as impurities and may prevent capsulation, thereby decreasing yield.

The phase change material in the capsule may be changed, for example, from a solid to a liquid as temperature increases because it is sensitive to temperature change. Therefore, the surface coating layer surrounding the surface of the microcapsule can be selected from various polymers that enable thermal stability to be secured during the fabrication of the composite, thereby safely encapsulating the phase change material. Generally, in order to mold a thermoplastic polymer, a melamine polymer having excellent thermal stability is used, and a carbon nanotube may be dispersed in the melamine in advance of the process of forming the surface coating layer. In an exemplary embodiment, the amount of the carbon nanotube may range from 0.1 to 2 wt % based on the amount of the melamine polymer, and a coating solution can be prepared by appropriate dispersal therein. If the concentration of the dispersing solution is less than 0.1 wt %, the amount of the carbon nanotube may be too small to form the coating layer; therefore, it can't be evenly distributed throughout the entire coating layer, which may prevent the conductive network from being formed. However, if the amount of carbon nanotube is over 2 wt %, the amount of the carbon nanotube will be too much compared to that of melamine, and it may not be suitable for use as a coating solution due to high viscosity.

In another exemplary embodiment, the amount of the carbon nanotube coating solution coated on the surface may range from about 0.1 to 10 wt %, preferably. Generally, because a carbon nanotube is hard to disperse in a polymer, the amount actually needed may become more than the theoretical amount to form the network. In order to solve this problem, the carbon nanotube may be coated on the microcapsule to obtain a micro-sized conductive filler, and therefore, dispersion and network formation can be easily conducted.

The mixing ratio of the carbon nanotube-coated microcapsule and the carbon fiber may range from 6:4 to 9:1 (weight ratio), and the amount of the carbon nanotube is relatively high to maintain the basic shielding characteristics , however, it will be appreciated that the compounding ratio may be varied according to the desired shielding efficiency and polymer properties for a particular application.

Further, when the carbon nanotube-coated microcapsule is mixed with carbon fiber and matrix polymer, the melting temperature may vary according to the kind of the thermoplastic resin to be used. Preferably, the melt compounding temperature of the compounded mixture may range from 180 to 300° C. If the temperature is lower than 180° C., the matrix polymer may not be completely melted and therefore, the filler may not be uniformly mixed, and if the temperature is higher than 300° C., polymer chain break may be accelerated and therefore, the mechanical property of the polymer composite may be lower.

Generally, the biggest problem for fabricating a composite using carbon nanotube is dispersion. Carbon nanotube is hard to disperse in a general matrix polymer, and therefore, the filler in an amount of 10 wt % based on the matrix polymer are required to form a conductive network. Thus, in order to obtain the desired characteristics with a smaller amount of carbon nanotube, the phase change material may be prepared as a microcapsule and the carbon nanotube coated on the surface thereof.

Additionally, the hybrid polymer composite may further include various additives such as antioxidant, coloring agent, release agent, lubricant and light stabilizer, and the amount of the additives may be properly adjusted according to various facts such as desired final use and characteristics. Furthermore, because the hybrid polymer composite is a composite having improved dispersion property of the carbon nanotube, it can be used to fabricate a carbon nanotube molded body having excellent electromagnetic wave shielding efficiency with a relatively small amount of the carbon nano-particle, and the electromagnetic absorbing and shielding characteristics with respect to heat transfer may be improved by mixing a phase change material thereto at the time; additionally, this leads to an overall improvement in the general physical properties of the resulting hybrid polymer composite.

Hereinafter, the following Examples are intended to illustrate the present invention without limiting its scope.

### EXAMPLE

### Fabrication of a Hybrid Polymer Composite Comprising Microcapsule Containing Carbon Nanotube-Coated Phase Change Material, and Carbon

2 g of octadecane kept at 50° C. was slowly added and dispersed to a 5% aqueous solution of anhydrous styrene-maleic acid copolymer as a surfactant in a 500 mL three neck flask equipped with a condenser and a stirrer, and the resulting solution was forcibly emulsified using a homogenizer (IKA T-50 basic) at 5,000 rpm for 10 min. Then, a coating solution to form a surface layer on a capsule was prepared. First, melamine (0.05 mole) and formaldehyde (0.25 mole, 37% solution) were mixed and reacted at 60° C. for 20-25 min to obtain a semitransparent polymer precursor. A multi-walled carbon nanotube 0.5 wt % was added to the polymer precursor and mixed with stirring at 500 rpm. The resulting mixture was added to the emulsion prepared above and stirred at reaction temperature of 80 85° C. for 2 hours to form a coating layer. After forming microcapsule, centrifugation was conducted to separate the formed particles.

As a matrix polymer, a thermoplastic polymer, polypropylene was used. The carbon nanotube-coated microcapsule and carbon fiber (weight ration of 6:4), the matrix polymer, and a filler 10 wt % based on the weight of the matrix polymer were uniformly mixed using

Haake Extruder mixer at the melting temperature of 230° C. at 100 rpm. The obtained pallet type compounded material was compressed using a compression mold to the thickness of 3 mm to obtain a composite.

### COMPARATIVE EXAMPLE

### Fabrication of Composite Comprising Carbon Nanotube and Carbon Fiber

As a matrix polymer, a thermoplastic polymer, polypropylene was used. A multi-walled carbon nanotube and carbon fiber (weight ratio of 6:4), a matrix polymer, and a filler 10 wt % based on the weight of the matrix polymer were uniformly mixed using a Haake Extruder mixer at the melting temperature of 230° C. at 100 rpm. The obtained pallet type compounded material was compressed using a compression mold to the thickness of 3 mm to obtain a composite.

### TEST EXAMPLE

### Comparison of Electromagnetic Wave Shielding Efficiencies of Composites Prepared in Example and Comparative Example

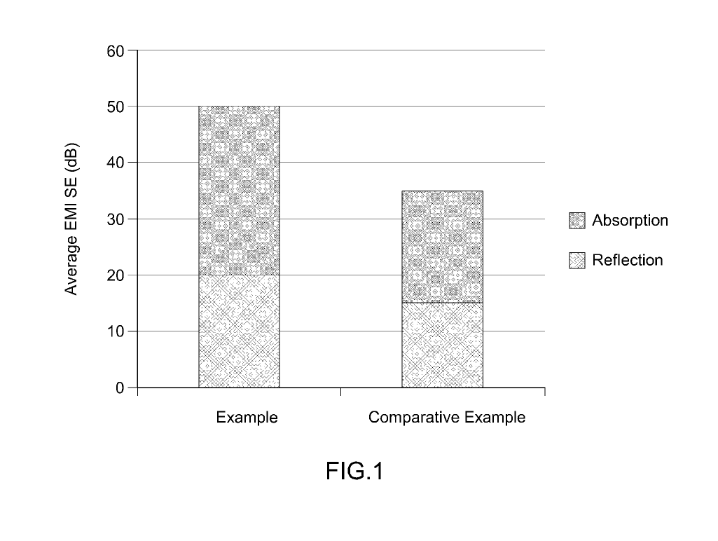

To each of the prepared composites, electromagnetic waves were measured using an electromagnetic wave shielding detector (E 8362B Agilent), and the ratio of reflection and absorption of electromagnetic shielding efficiency was checked. Consequently, as shown in FIG. 1, the composite of Example showed higher electromagnetic wave shielding absorbing characteristics than the composite of Comparative Example. From this fact, it is confirmed that when the same amount of filler is added, using a phase change material, which can absorb heat, produces a composite that shows better efficiency than that using a carbon nanotube alone. Particularly, when the amounts of the added carbon nanotube are compared, the method using a capsule used the minimum amount of the carbon nanotube but showed better efficiency. Namely, a polymer composite having excellent physical properties and shielding efficiency can be fabricated by preparing a microcapsule containing a phase change material followed by mixing the particle coated with a carbon nanotube on the surface thereof and a carbon fiber, and the obtained polymer composite can be applied to various devices requiring electromagnetic wave shielding characteristics.

According to one exemplary embodiment of the present invention, the hybrid polymer composite includes a microcapsule containing a phase change material therein to easily remove heat generated by absorbing and shielding so as to enhance electromagnetic wave shielding efficiency, and it can be fabricated by compounding the microcapsule coated with a carbon nanotube on the surface thereof with a carbon fiber and a matrix polymer for effective dispersion in the matrix resin to secure polymer properties and to form a network between fillers at the same time so as to obtain excellent conductivity.

Further, as a result of increasing the dispersion property of the nano-filler and giving a function to the polymer, the composite can be applied to various fields requiring electromagnetic wave shielding such as vehicle ECU (electronic control unit) housing, electric vehicle parts, mobile phone, display housing and the like.

While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

What is claimed is:

1. A hybrid polymer composite, comprising:
at least one microcapsule;
at least one phase change material (PCM);
at least one carbon nanotube;
at least one carbon fiber; and
at least one matrix polymer, wherein the at least one microcapsule is surface-coated with at least one carbon nanotube, and comprises at least one phase change material.

2. The hybrid polymer composite of claim 1, wherein the at least one PCM is selected from the group consisting of a C₁₃₋₂₈ paraffin (CₙH₂ₙ₊₂), a fatty acid(CH₃(CH₂)₂ₙCOOH), and any mixture thereof.

3. The hybrid polymer composite of claim 1, wherein the at least one carbon nanotube is selected from the group consisting of a single-walled carbon nanotube (SWNT), a double-walled carbon nanotube (DWNT), a multi-walled carbon nanotube (MWNT), and any mixture thereof.

4. The hybrid polymer composite claim 1, wherein the at least one carbon nanotube has a thickness from 50 nm to 500 nm

5. The hybrid polymer composite of claim 1, wherein the at least one microcapsule has a diameter from 1 μm to 100 μm.

6. The hybrid polymer composite of claim 1, wherein the at least one carbon nanotube is surface-coated on the microcapsule at an amount from 0.1 wt % to 10 wt %.

7. The hybrid polymer composite of claim 1, wherein the at least one matrix polymer is selected from the group consisting of polyethylene, polypropylene, polystyrene, polyalkylene terephthalate, polyamide resin, polyacetal resin, polycarbonate, polysulfone, polyimide, and any mixture thereof.

8. A method for fabricating the hybrid polymer composite of claim 1, comprising:
preparing an emulsion by adding at least one phase change material (PCM) to a surfactant;
preparing a carbon nanotube coating solution by dispersing at least one carbon nanotube in a melamine polymer;
preparing a microcapsule by combining the emulsion with the carbon nanotube coating solution;
preparing a mixture by compounding at least one carbon fiber and at least one matrix polymer with the microcapsule coated with the carbon nanotube; and
compressing the mixture in a compression mold to obtain the hybrid polymer composite.

9. The method of claim 8, wherein the surfactant is selected from the group consisting of carboxylate, sulfonated, sulfuric acid ester salt, and any combination thereof.

10. The method of claim 8, wherein the surfactant and the PCM are combined at a mixing ration of 2:1

11. The method f of claim 8, wherein the amount of the at least one carbon nanotube ranges from 0.1 wt % to 2 wt % relative to the amount of the melamine polymer.

12. The method of claim 8, wherein the amount of the carbon nanotube coating solution used for the surface coating ranges from 0.1 wt % to 10 wt %.

13. The method of claim 8, wherein the mixing ratio of the microcapsule coated with the carbon nanotube and the carbon fiber ranges from 6:4 to 9:1 (weight ratio).

14. The method of claim 8, wherein a melt compounding temperature of the compounded is from 180° C. to 300° C.
